(19) United States
(12) Patent Application Publication
(10) Pub. No.: US 2026/0293870 A1
(43) Pub. Date: Oct. 1, 2026

(54) HANDHELD TOOL FOR RIGGING SOFT PLASTIC LURES

(71) Applicant: Jackson STUART, Queensland (AU)

(72) Inventor: Jackson STUART, Queensland (AU)

(21) Appl. No.: 19/630,806

(22) Filed: Mar. 27, 2026

(30) Foreign Application Priority Data
Mar. 28, 2025 (AU) 2025901033

(51) Int. Cl. A01K 97/00; B25B 9/02

(52) U.S. Cl. CPC A01K 97/00; B25B 9/02

(57) ABSTRACT

A hand-held tool for rigging a soft plastic lure to a hook or jig head, comprising: first and second lure clamping portions that are biased to be manually moved towards each other into a clamping position from an initial neutral and open position by applying a manual force on outer surfaces of the clamping portions to overcome a biasing force, the lure clamping portions being mutually opposed and having respective lure engaging surfaces extending in an in-use vertical direction, the lure engaging surfaces having a length to sufficiently to secure the soft plastic lure in a straight orientation during rigging; finger guards extending from respective lure clamping portions to shield a user's fingers from inadvertent contact with the hook or jig head while the soft plastic lure is manually clamped between the lure clamping portions.

### RELATED APPLICATION

This application claims the benefit of priority of Australia Patent Application No. 2025901033 filed on Mar. 28, 2025, the contents of which are all incorporated herewith by reference in their entirety.

### FIELD AND BACKGROUND OF THE INVENTION

The present disclosure pertains to a system and method for rigging soft plastic lures in fishing equipment.

Any references to methods, apparatus or documents of the prior art are not to be taken as constituting any evidence or admission that they formed, or form part of the common general knowledge.

A lure comprised of natural or artificial bait is typically attached to the hook and a user holding the handle casts the fishing line by flicking the rod so that the hook with bait and sinker are launched out onto the surface of a body of water a distance away from the user. The sinker causes the hook with the bait attached to sink down below the water surface and sometimes to the bottom of the water. Fish are attracted by the bait and swallow the bait and the hook and are thereby tethered to the fishing line. The user recovers the fish by operating the cranked reel to wind the fishing line onto the spool.

A fishing jig is a type of weighted fishing lure that comprises a sinker attached to the shank of a hook. Fishing jigs typically include an eyelet for connection with fishing line. The eyelet is sometimes attached to the sinker and either aligned coaxially or transversely with the shank of the hook.

Rigging soft plastic fishing lures plays a significant role in angling, as the performance of the lure often relies on the accuracy with which the hook or jig head is inserted. Creating a straight, lifelike swim profile necessitates careful alignment, but the pliable and slippery nature of soft plastic materials complicates this process. Incorrect rigging can lead to lures that swim in an unnatural manner, diminishing their appeal to fish and affecting the outcome of fishing endeavours.

Existing solutions for rigging soft plastic lures include the use of O-rings, adhesives, or brand-specific fixtures. While these approaches may offer some degree of convenience, they are frequently limited in their applicability. O-ring systems, for example, are often suitable only for certain types or sizes of soft plastic lures and may not provide a universal solution. Brand-specific rigging systems tend to be designed for proprietary lure shapes and sizes, restricting their use to a narrow range of products and preventing anglers from utilizing a single tool across different lure types. Additionally, many of these solutions are single-use or disposable, requiring anglers to carry multiple tools or replacement parts and perform time-intensive adjustments during fishing trips.

Another significant concern in the rigging process is safety. Handling exposed hooks or jig heads without integrated safeguards increases the risk of accidental injury to the hands and fingers. Many available devices lack features that protect the user during the rigging process, especially when force is required to insert the hook or jig head into the lure. This not only poses a safety hazard but also discourages less experienced anglers from attempting to rig their own lures.

Portability and ease of use are also important considerations for anglers who travel or fish in remote locations. Few compact, universally adaptable devices combine secure clamping and hand protection in a portable form. The absence of a streamlined, reusable tool that can accommodate a wide variety of soft plastic lures and jig heads, while also providing safety features and maintaining the correct alignment of the lure, highlights the need for improved solutions in this area.

Accordingly, there remains a need for a device that addresses the limitations of existing rigging tools by providing a safe, portable, and universally adaptable solution for rigging soft plastic lures in a manner that ensures proper alignment and reduces the risk of injury.

### SUMMARY OF THE INVENTION

In an aspect, the invention provides a hand-held tool for rigging a soft plastic lure to a hook or jig head, comprising:
first and second lure clamping portions that are biased to be manually moved towards each other into a clamping position from an initial neutral and open position by applying a manual force on outer surfaces of the clamping portions to overcome a biasing force,
the lure clamping portions being mutually opposed and having respective lure engaging surfaces extending in an in-use vertical direction, the lure engaging surfaces having a length to sufficiently to secure the soft plastic lure in a straight orientation during rigging;
finger guards extending from respective lure clamping portions to shield a user's fingers from inadvertent contact with the hook or jig head while the soft plastic lure is manually clamped between the lure clamping portions.

In an embodiment, the biased lure clamping portions are joined by a biasing portion that is integrally formed with the lure clamping portion to form a clamping body.

In an embodiment, the biasing portion comprises a curved joining member that joins the clamping portions, the curved joining member being sufficiently resilient to apply a resilient bias to the biased lure clamping portions.

In an embodiment, the biasing portion is narrower than each of the lure clamping portions.

In an embodiment, an in-use top part of the lure clamping portions are curved to allow the clamping body to be accommodated substantially within a closed fist of a user such that the outer surface of one of the clamping portions can be positioned against the palm of the user and the outer surface of the other of the clamping portions is positioned against the fingers of the user when the user is holding the tool within the closed fist.

In an embodiment, the handheld tool further comprises respective finger guards positioned relative to end portions of the corresponding lure engaging surfaces.

In an embodiment, the finger guards extend transversely relative to end portions of the corresponding lure engaging surfaces.

In an embodiment, the finger guards extend in the in-use vertical direction along the length of the corresponding lure engaging surfaces.

In an embodiment, the finger guards extend along the entire length of the lure engaging surfaces.

In an embodiment, the finger guards are substantially flat.

In an embodiment, the finger guards are integrally formed with the lure clamping portions.

In an embodiment, the hand-held tool further comprises an indicator associated with the lure clamping sections to assist in determining a distance for drawing the hook through the soft plastic lure.

In an embodiment, the indicator is provided along one of the finger guards.

In an embodiment, a respective indicator is provided along each of said finger guards.

In an embodiment, the biased clamping portions, in the neutral open position, are sized to be operated by a single hand to allow the user to single-handedly move the clamping portions towards each other to clamp and secure the soft plastic lure in a straight orientation between the lure engaging surfaces.

In another aspect, there is provided a method for rigging a soft plastic lure, comprising:
securing the soft plastic lure in a straight orientation between biased first and second lure clamping portions by manually moving the clamping portions towards each other from an initial neutral and open position by applying a manual force on outer surfaces of the clamping portions by overcoming a biasing force;
inserting a hook or jig head into the soft plastic lure; and
releasing the soft plastic lure from the lure clamping portions by allowing the biased clamping portions to return to the initial neutral position by withdrawing the application of manual force on the clamping portions.

### BRIEF DESCRIPTION OF THE SEVERAL VIEWS OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a first top perspective view of the hand-held tool 10 in accordance with an embodiment.

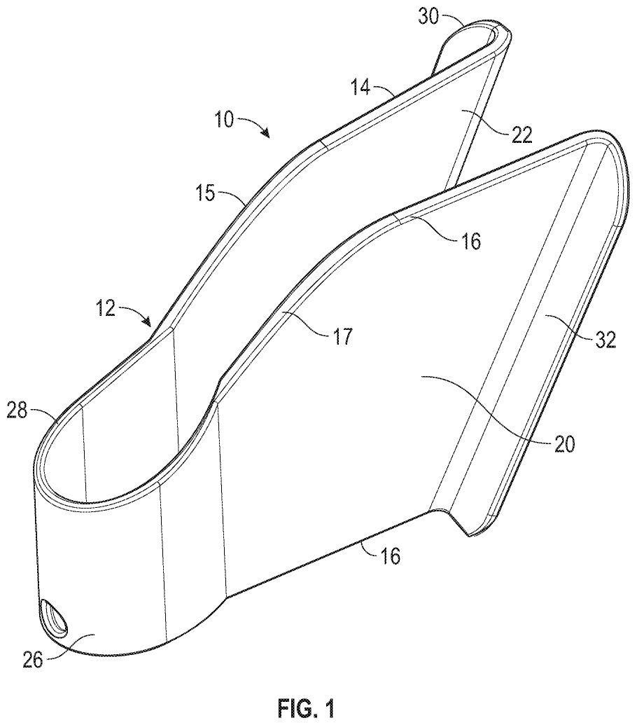

FIG. 2 is a frontal perspective view of the hand-held tool 10.

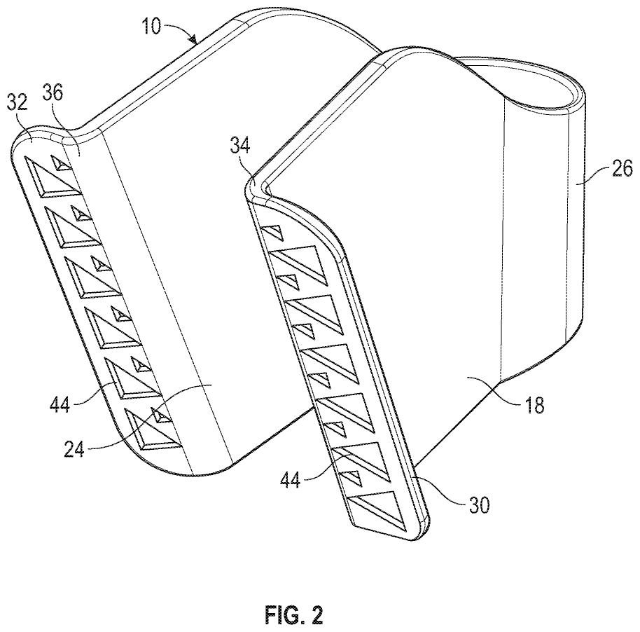

FIG. 3 is a side view of the hand-held tool 10.

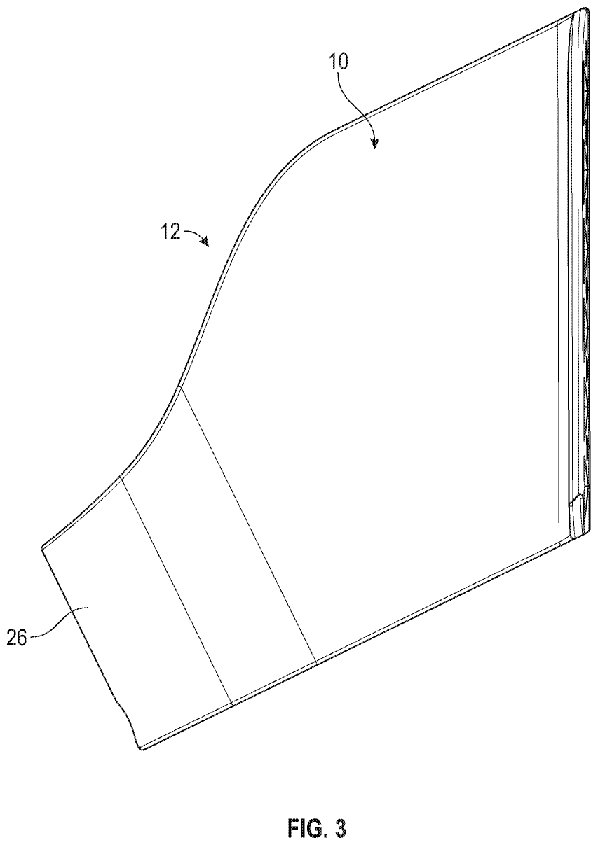

FIG. 4 is a bottom perspective view of the hand-held tool 10.

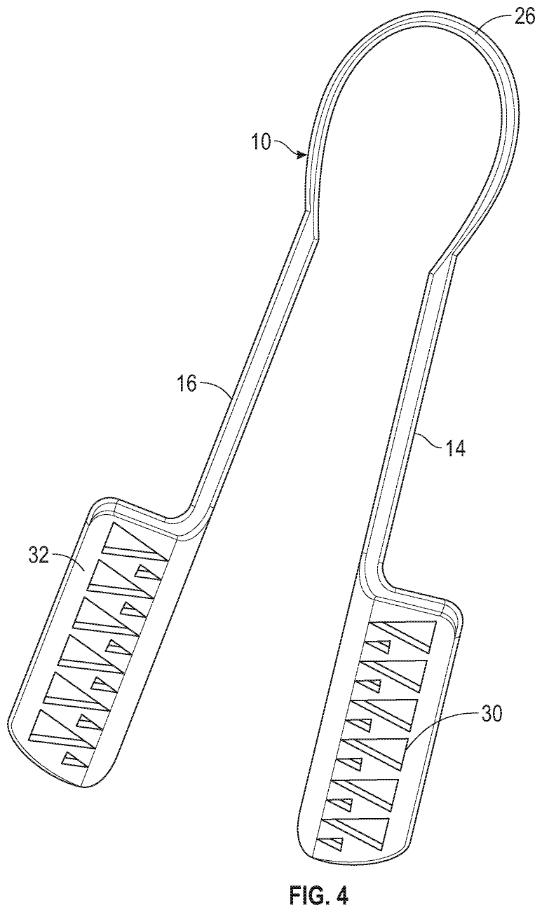

FIG. 5 is an in-use side view of the hand-held tool 10 with the soft plastic lure being positioned in a substantially vertical orientation.

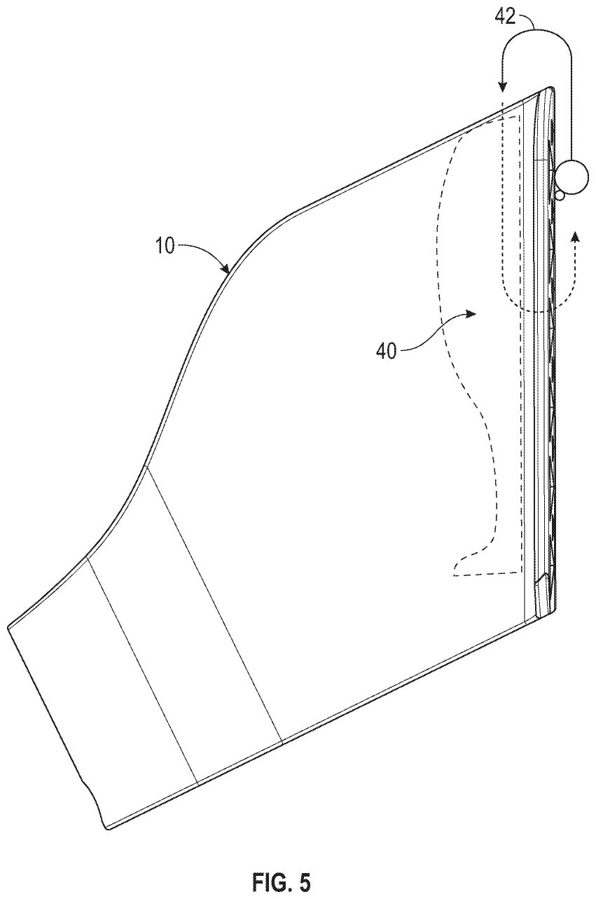

FIG. 6 is an in-use side view of the hand-held tool 10.

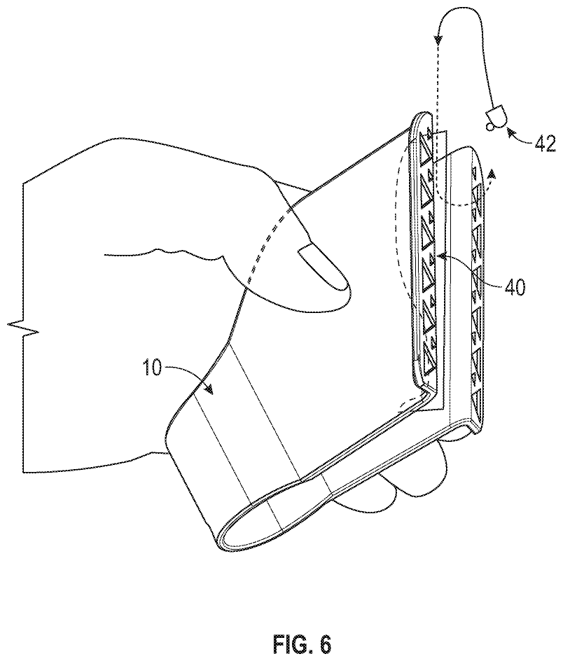

### DESCRIPTION OF SPECIFIC EMBODIMENTS OF THE INVENTION

In some embodiments, a hand-held tool 10 is provided for rigging a soft plastic lure 40 to a hook or jig head 42. The tool 10 may be configured as a compact clamping body 12 sized to be operated by a single hand of a user. The tool 10 may include a first lure clamping portion 14 and a second lure clamping portion 16 that are mutually opposed to define a lure receiving region therebetween. The first and second lure clamping portions 14, 16 may each include respective outer surfaces 18, 20 that are engaged by the user during operation, and respective lure engaging surfaces 22, 24 that face one another and contact opposite sides of the soft plastic lure 40 during rigging. In some embodiments, the lure engaging surfaces 22, 24 extend in an in-use vertical direction and have sufficient length to hold the soft plastic lure 40 in a substantially straight orientation while the hook or jig head 42 is inserted into the lure 40.

The first and second lure clamping portions 14, 16 may be biased away from one another to define an initial neutral and open position of the tool 10. From that open position, the user may apply a manual squeezing force to the outer surfaces 18, 20 to move the first and second lure clamping portions 14, 16 toward one another and into a clamping position. In the clamping position, the lure engaging surfaces 22, 24 may grip and secure the soft plastic lure 40 so that the lure 40 is retained against twisting, bending, or other misalignment while rigging is performed. By maintaining the body of the lure 40 in a straight condition, the tool 10 may assist the user in drawing the hook or jig head 42 through the lure 40 in a manner that preserves the intended alignment of the lure 40.

In some embodiments, the clamping body 12 is integrally formed and includes a biasing portion 26 joining the first and second lure clamping portions 14, 16. The biasing portion 26 may be formed as a curved joining member 28 located at a lower or base region of the clamping body 12. The curved joining member 28 may be sufficiently resilient to provide a spring-back action such that, when the manual squeezing force applied to the outer surfaces 18, 20 is released, the first and second lure clamping portions 14, 16 return toward the neutral open position. In this manner, the tool 10 may have a self-opening function that facilitates repeated fitting and removal of soft plastic lures 40. In some embodiments, the biasing portion 26 is narrower than each of the first and second lure clamping portions 14, 16, thereby enabling the clamping portions 14, 16 to flex relative to one another while still being joined as a single unitary structure. It is also important to appreciate that the presently described embodiment is not limited by the structure of the biasing arrangement shown. In other alternative embodiments, other forms of biasing arrangements may also be provided to facilitate the aforementioned clamping function of the clamping portions 14 and 16.

The clamping body 12 may be manufactured from a resilient material capable of repeated elastic deformation and recovery. In some embodiments, the clamping body 12 is formed from a bent piece of material that inherently provides the biasing force required to return the tool 10 to the neutral open position after use. Because the biasing action may be provided by the material of the clamping body 12 itself, separate springs or complex moving parts may be omitted. This may contribute to a structure that is portable, reusable, and suitable for repeated rigging operations. In some embodiments, the tool 10 may be formed as a one-piece body, although other embodiments may employ joined sections provided they function together to form the clamping body 12 described herein.

In some embodiments, upper regions 15, 17 of the first and second lure clamping portions 14, 16 are curved so that the clamping body 12 can be accommodated substantially within a closed fist of the user. For example, when the user grips the tool 10, the outer surface 18 of the first lure clamping portion 14 may be positioned adjacent the palm, while the outer surface 20 of the second lure clamping portion 16 may be positioned adjacent the fingers. Such an arrangement may permit the user to squeeze the first and second lure clamping portions 14, 16 together with one hand, thereby leaving the other hand available to manipulate the hook or jig head 42. The compact, hand-fitting configuration may also improve portability and permit the tool 10 to be readily carried by an angler during travel or use in the field.

The lure engaging surfaces 22, 24 may be configured to contact the soft plastic lure 40 along a sufficient vertical length to stabilize the lure 40 during insertion of the hook or jig head 42. In some embodiments, the lure engaging surfaces 22, 24 are relatively smooth so that the lure 40 is held firmly without undue damage to the soft plastic material. The opposed arrangement of the lure engaging surfaces 22, 24 may allow different portions of the lure body to be supported while the lure 40 is maintained in a straight body position. This may assist in reducing crooked rigging, which can adversely affect the swimming action of the lure 40 in use. In some embodiments, the dimensions of the lure engaging surfaces 22, 24 may be selected to accommodate a range of lure sizes and profiles while still maintaining useful clamping performance.

To improve user safety, the tool 10 may further include a first finger guard 30 extending from the first lure clamping portion 14 and a second finger guard 32 extending from the second lure clamping portion 16. The finger guards 30, 32 may be positioned relative to end portions 34, 36 of the corresponding lure engaging surfaces 22, 24 so as to shield the user's fingers or hand from inadvertent contact with the hook or jig head 42 during rigging. In some embodiments, the finger guards 30, 32 extend transversely relative to the end portions 34, 36 of the lure engaging surfaces 22, 24. In some embodiments, the finger guards 30, 32 also extend in the in-use vertical direction along the length of the corresponding lure engaging surfaces 22, 24. The finger guards 30, 32 may extend along the entire length of the lure engaging surfaces 22, 24, or along a substantial portion thereof, so as to form a protective barrier between the rigging area and the user's gripping hand.

In some embodiments, the finger guards 30, 32 are substantially flat members. The flat configuration may provide a practical shield surface while also allowing the overall form of the tool 10 to remain compact. The finger guards 30, 32 may be integrally formed with the respective lure clamping portions 14, 16 as part of the clamping body 12. In other embodiments, the finger guards 30, 32 may be coupled to the clamping portions 14, 16 while still functioning as protective extensions thereof. The finger guards 30, 32 may be located at an end region of the clamping body 12 such that, if the lure 40 slips during rigging or if the hook or jig head 42 is driven unexpectedly toward the user, the finger guards 30, 32 reduce the likelihood of direct contact with the user's fingers.

In some embodiments, the tool 10 further includes indicators 44 associated with the lure clamping portions 14, 16 to assist the user in determining a distance for drawing the hook or jig head 42 through the soft plastic lure 40. The indicator 44 may be in the form of a hook guide marking, label, line, scale, or other visual reference. In some embodiments, the indicator 44 is provided along each of the finger guards 30, 32. In some embodiments, a respective indicator 44 is provided along each of the finger guards 30, 32. The indicator 44 may assist the user in selecting an appropriate exit location or travel distance for the hook or jig head 42 relative to the body of the lure 40 so that the lure 40 is rigged in an intended orientation. This may improve consistency in rigging and may help achieve a straighter final assembly of the lure 40 and hook or jig head 42.

In use, the user may position the soft plastic lure 40 between the first and second lure clamping portions 14, 16 while the tool 10 is in the neutral open position. The user may then apply manual pressure to the outer surfaces 18, 20 to move the clamping portions 14, 16 toward one another until the lure engaging surfaces 22, 24 clamp the lure 40 and hold the lure 40 in a straight orientation. With the lure 40 secured in this manner, the user may insert the hook or jig head 42 into the lure 40 and draw the hook or jig head 42 through the lure 40 while the fingers remain shielded by the finger guards 30, 32. Once rigging is complete, the user may reduce or withdraw the squeezing force applied to the outer surfaces 18, 20, thereby allowing the biasing portion 26 to return the first and second lure clamping portions 14, 16 toward the neutral open position and release the rigged lure 40.

The described construction may provide a reusable tool that can be employed repeatedly with different soft plastic lures 40 and different hooks or jig heads 42. By combining the clamping function, the resilient self-opening function, and the protective finger guards 30, 32 in a single hand-held structure, the tool 10 may provide a practical rigging aid that assists in maintaining lure alignment while improving user safety. In some embodiments, the tool 10 is sufficiently small and portable to fit within one hand during use and to be conveniently carried when not in use.

Although particular arrangements of the tool 10 have been described, the disclosed subject matter is not limited to the specific configurations shown. In some embodiments, the relative dimensions of the clamping portions 14, 16, the finger guards 30, 32, and the biasing portion 26 may be varied to suit different lure profiles, user preferences, or manufacturing approaches. Likewise, the exact shape and placement of the indicator 44 may be varied provided that the indicator 44 remains associated with the clamping structure in a manner that assists rigging. The disclosed embodiments therefore encompass variations in form and arrangement while retaining the functional relationship of opposed biased clamping portions for holding a soft plastic lure in a straight orientation and protective guard structure for shielding the user during insertion of a hook or jig head.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A hand-held tool for rigging a soft plastic lure to a hook or jig head, comprising:
first and second lure clamping portions that are biased to be manually moved towards each other into a clamping position from an initial neutral and open position by applying a manual force on outer surfaces of the clamping portions to overcome a biasing force,
the lure clamping portions being mutually opposed and having respective lure engaging surfaces extending in an in-use vertical direction, the lure engaging surfaces having a length to sufficiently to secure the soft plastic lure in a straight orientation during rigging;
finger guards extending from respective lure clamping portions to shield a user's fingers from inadvertent contact with the hook or jig head while the soft plastic lure is manually clamped between the lure clamping portions.

2. A hand-held tool in accordance with claim 1, wherein the biased lure clamping portions are joined by a biasing portion that is integrally formed with the lure clamping portion to form a clamping body.

3. A handheld tool in accordance with claim 2, wherein the biasing portion comprises a curved joining member that joins the clamping portions, the curved joining member being sufficiently resilient to apply a resilient bias to the biased lure clamping portions.

4. A handheld tool in accordance with claim 2, wherein the biasing portion is narrower than each of the lure clamping portions.

5. A handheld tool in accordance with claim 2, wherein an in-use top part of the lure clamping portions are curved to allow the clamping body to be accommodated substantially within a closed fist of a user such that the outer surface of one of the clamping portions can be positioned against the palm of the user and the outer surface of the other of the clamping portions is positioned against the fingers of the user when the user is holding the tool within the closed fist.

6. A handheld tool in accordance with claim 1, further comprising respective finger guards positioned relative to end portions of the corresponding lure engaging surfaces.

7. A hand-held tool in accordance with claim 6, wherein the finger guards extend transversely relative to end portions of the corresponding lure engaging surfaces.

8. A hand-held tool in accordance with claim 6, wherein the finger guards extend in the in-use vertical direction along the length of the corresponding lure engaging surfaces.

9. A hand-held tool in accordance with claim 6, wherein the finger guards extend along the entire length of the lure engaging surfaces.

10. A hand-held tool in accordance with claim 6, wherein the finger guards are substantially flat.

11. A handheld tool in accordance with claim 6, wherein the finger guards are integrally formed with the lure clamping portions.

12. A hand-held tool in accordance with claim 1, further comprising an indicator associated with the lure clamping sections to assist in determining a distance for drawing the hook through the soft plastic lure.

13. A hand-held tool in accordance with claim 12, wherein the indicator is provided along one of the finger guards.

14. A handheld tool in accordance with claim 13, wherein a respective indicator is provided along each of said finger guards.

15. A hand-held tool in accordance with claim 1, wherein the biased clamping portions, in the neutral open position, are sized to be operated by a single hand to allow the user to single-handedly move the clamping portions towards each other to clamp and secure the soft plastic lure in a straight orientation between the lure engaging surfaces.

16. A method for rigging a soft plastic lure, comprising:
securing the soft plastic lure in a straight orientation between biased first and second lure clamping portions by manually moving the clamping portions towards each other from an initial neutral and open position by applying a manual force on outer surfaces of the clamping portions by overcoming a biasing force;
inserting a hook or jig head into the soft plastic lure; and
releasing the soft plastic lure from the lure clamping portions by allowing the biased clamping portions to return to the initial neutral position by withdrawing the application of manual force on the clamping portions.
